(19) United States
(12) Patent Application Publication
(10) Pub. No.: US 2011/0315628 A1
(43) Pub. Date: Dec. 29, 2011

(54) System and method for capturing and bioremediating hydrocarbon pollutants using dynamic filters

(76) Inventors: Mark D. Shaw, Ponte Vedra Beach, FL (US); J. Tad Heyman, Atlantic Beach, FL (US)

(21) Appl. No.: 13/135,024

(22) Filed: Jun. 23, 2011

Related U.S. Application Data
(60) Provisional application No. 61/398,338, filed on Jun. 24, 2010.

(51) Int. Cl. C02F 3/00; B01D 24/00; C02F 1/28

(52) U.S. Cl. 210/615; 210/151

(57) ABSTRACT

A dynamic filter member comprising a mass of lipophilic, hydrophobic fibers and bioremediating microbes, said filter member having a sufficient volume of interstitial areas such that water flow through said filter member is substantially unimpeded.

This application claims the benefit of U.S. Provisional Patent Application Ser. No. 61/398,338, filed Jun. 24, 2010.

### BACKGROUND OF THE INVENTION

This invention relates generally to the field of methods, systems and apparatuses for capturing and bioremediating hydrocarbon pollutants, such as can occur in oil spills on land or in the water. More particularly, the invention relates to such methods, systems and apparatuses that utilize naturally occurring bioremediating microbes having an affinity for the hydrocarbon pollutants as a food source, whereby the microbes convert the hydrocarbons into environmentally safe byproducts. The invention also relates to such methods, systems and apparatuses that utilize dynamic fibrous adsorbent and absorbent structures to capture or filter hydrocarbons while allowing passage of water through the filter member.

Large hydrocarbon (i.e., oil) spills and leaks, such as occur from pipeline ruptures, ship accidents or oil well failures, are extremely hazardous and have disastrous environmental effects. Land, shorelines, beaches, rivers, lakes and oceans polluted by oil may be contaminated for years, with resulting negative effects on wildlife and local economies. It is known to provide absorbent members retaining bioremediating microbes, the absorbent members absorbing hydrocarbons, but these prior absorbent members do not act as true filters as they do not allow passage of water through the device. Thus, the absorbent members only work by static contact with the hydrocarbon, rather than being dynamic filtering devices. In a sense, the known devices would be the equivalent of attempting to filter tap water by dropping a carbon filter block into a pitcher of water rather than passing the tap water through the carbon filter block and into the container. In addition, because the known absorbent devices block the flow of water, they cannot be used in high current situations, as the water current will push the devices downstream unless anchored, and if anchored may cause the devices to submerge under the force of the current flow.

It is an object of this invention to provide methods, systems and apparatuses for capturing and bioremediating hydrocarbon pollutants, especially in circumstances where large amounts of hydrocarbon pollutants are released into an environment at one time or where large amounts of hydrocarbon pollutants are released in a widespread area, wherein dynamic filter members are provided that are capable of retaining bioremediating microbes, absorbing hydrocarbons, and permitting water to flow through.

### SUMMARY OF THE INVENTION

The invention is in general a system and method that combines capture and filtration of hydrocarbon pollutants with bioremediation of the captured hydrocarbon by microbes having an affinity for the hydrocarbon as a food source, wherein water is permitted to flow through the device with minimal interference. A dynamic filter member composed of a fibrous mass or wad of lipophilic and hydrophobic fibers is provided, the filter member being constructed to have a large volume of interstitial areas to allow for passage of water through the filter member while increasing the ability of the filter member to retain hydrocarbon within the filter. Bioremediating microbes having an affinity for hydrocarbons as a food source are infused, adsorbed or otherwise entrapped or retained within or on the filter member. The filter member may be provided in the form of pads, mats, sheets, ribbons, booms, blankets or the like. The filter member is then placed into a body of water containing undesirable hydrocarbons, the body of water having a current or flow. As water passes through the filter member, the hydrocarbon is then absorbed by the filter member, allowing the microbes to render the hydrocarbon non-hazardous by converting it into non-hazardous byproducts, while filtered water readily passes from the filter member.

### BRIEF DESCRIPTION OF THE DRAWINGS

FIG. 1 is a representative embodiment showing the filter member as a sheet, mat or pad.

FIG. 2 is a representative embodiment in partial cross-section showing the filter member as a roll or berm and with a cover member.

### DETAILED DESCRIPTION OF THE INVENTION

With reference to he drawings, the invention will now be described in detail with regard for the best mode and the preferred embodiment(s). As used herein, the term “dynamic” shall be taken to mean that filtration occurs dynamically rather than statically, that the removal of hydrocarbons from the water occurs as the water passes through the filter member rather than merely by static contact.

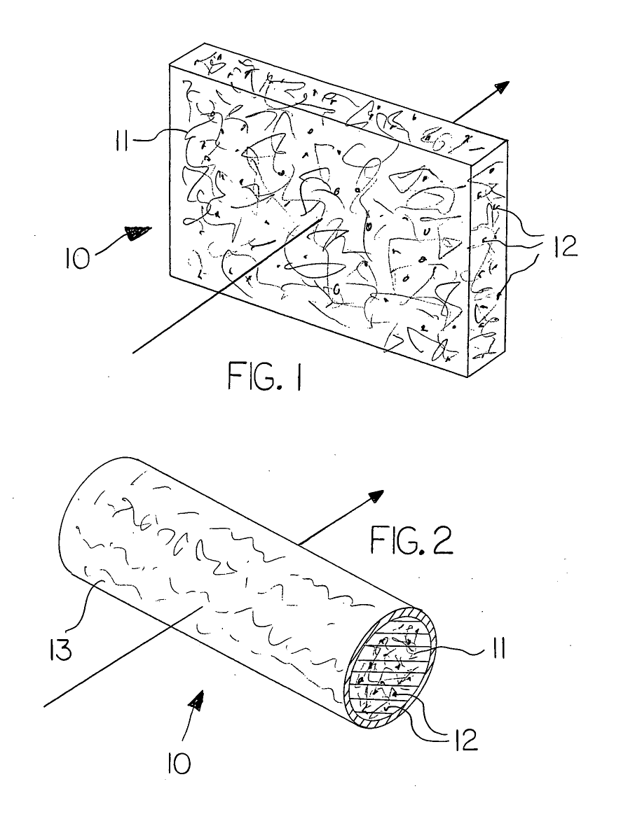

The dynamic filter member 10 is a mass or wad of lipophilic, hydrophobic fibers 11, formed to be self-sustaining, as shown in FIG. 1, or retained within a porous cover 13, as shown in FIG. 2. The fibers 11 adsorb hydrocarbons directly, and the filter member 10 is constructed such that a large volume of interstitial areas exists within the filter member 10, the interstitial areas serving to increase the porosity of the filter member 10, thereby both increasing the absorption rate of hydrocarbons and increasing the pass-though ability of water, as well as providing an increased volume for absorption, i.e., entrapment, of the hydrocarbon within the filter member 10. The volume of interstitial areas is sufficient to allow water passage that is substantially unimpeded. Thus, the individual fibers 11 composing the filter member 10 are hydrophobic, while the filter member 10 itself can be considered to hydrophilic and dynamic, since the influx and passage of water is maximized, such that the amount of hydrocarbons absorbed by the filter member 10 is also maximized. This characteristic is especially useful for hydrocarbon contamination in aqueous environments such as rivers, lakes and oceans where currents, tides and flow exist. The relatively easy passage of water into and through the filter member 10 insures that the filter member 10 does not become quickly clogged by surface-adsorbed hydrocarbons, since a larger quantity of hydrocarbons will be brought into the interior of the filter member 10 during passage of water through the filter member 10. Preferably the filter member 10 allows from between 50 to 150 gallons per minute per square foot of water flow therethrough, measured prior to absorption of any hydrocarbons.

The lipophilic, hydrophobic fibers 11 are preferably composed of synthetic materials, such as for example polymer fibers 11 such as polypropylene, polyester, nylon, etc. Filter members 10 comprising masses of short and long polymer fibers 11 have been found to be suitable, in particular wherein the fibers 11 are delustered to increase the surface area of the fibers 11, which increases the amount of adsorption per fiber 11 and the interstitial volume available for absorption. The long polymer fibers 11 maintain the cohesiveness of the fibrous mass, with an increase in the relative number of long fibers 11 over short fibers 11 increasing the self-sustaining nature of the mass. As a representative example, fibrous masses sold under the brand name X-TEX have been found to be suitable for the purposes described herein. The production of such material is disclosed in U.S. Pat. No. 6,632,501, the disclosure of which is incorporated herein by reference.

The filter member 10 can be provided in many forms, such as a pad, mat, blanket, sheet, sack, ribbon, floating boom or the like. The filter member 10 may be a self-sustaining mass, or may further comprise a cover or container 13 for the mass, wherein the cover or container 13 is porous so as to allow for the passage of oil and water.

Because the filter member 10 adsorbs hydrocarbon onto the fibers 11 and in the interstitial areas, while allowing for easy passage of water into and from the filter member 10 during capture of the hydrocarbon, the filter member 10 can be easily cleaned and reused by pressing or squeezing the filter member 10 to release the majority of the absorbed hydrocarbon and a large amount of the adsorbed hydrocarbon from the filter member 10. The filter member 10 may be further cleaned if desired by known cleaning processes that will not damage the fibers 11.

The filter member 10 further comprises a large quantity of microbes 12 having an affinity for hydrocarbon as a food source. The microbes 12 are preferably naturally occurring microbes, and preferably the colonies of the microbes 12 are cultivated or “trained” so as to increase their affinity for hydrocarbons by providing only crude oil as a food source. The microbe colonies are dried in known manner to render them dormant for storage. The microbes 12 reanimate when provided with water, oxygen and food source. Such microbes 12 are well known in the industry, have been approved by the EPA, and have been used in the past to bioremediate hydrocarbon spills. Suitable microbes 12 may comprise genus Pseudomonas, Candida, Geatriclum or Actinomucor, for example, and have been sold for example under the brand ALPHA BIOSEA.

The microbes 12 utilize the hydrocarbon as food, digesting and breaking down the hydrocarbon into harmless byproducts such as water, carbon, carbon dioxide and lipids. Once reanimated, the colonies expand rapidly from billions of members to trillions of members. Typically, a colony will have an effective lifespan of about three months under optimum conditions.

The microbes 12 are typically provided in the dormant state on carrier substances, such as for example a corn starch or bentonite clay. The microbe carrier substances can be mixed into the fibrous mass of the filter member 10 in the dry state or sprayed onto the filter member 10 in a fluid train, either prior to of after deployment of the filter member 10.

The microbes 12 are advantageous in several ways. For small amounts of hydrocarbon pollutants, such as thin oil sheens on water, the microbes 12 may completely remediate the hydrocarbon such that the filter member 10 remains free of hydrocarbons. For larger concentrations of hydrocarbon, the microbes 12 will dramatically extend the effective life of the filter member 10, since a significant portion of the hydrocarbon adsorbed and adsorbed by the filter member 10 will be remediated. If a saturated filter member 10 is removed from service, the microbes 12 will continue to remediate the hydrocarbon provided suitable environmental conditions are provided to sustain microbe life, eventually cleaning the filter member 10, enabling the filter member 10 to be reused or safely disposed of. In addition, especially in an aqueous environment, microbes 12 will migrate from the filter member 10 into the surrounding environment, remediating hydrocarbons that have not been captured by the filter member 10.

In methodology terms, a basic approach is to apply or position a microbe-infused filter member 10 in the water in the presence of the hydrocarbon pollutant, such as by placing filter members 10 directly onto a floating oil slick. Likewise, microbe-infused filter member 10 booms or fences can be positioned in the water or on shore where oil contaminants are expected to be spread by rising tides or wave action. For land circumstances, a beach or shore can first be treated with an application of the microbe carrier substance prior to any pollution, which will provide remediation means to attack the hydrocarbons upon initial encounter, with positioning or application of microbe-infused filter members 10 after the pollution event if needed.

It is understood that equivalents and substitutions for certain elements and structures set forth above may be obvious to those of ordinary skill in the art, and therefore the true scope and definition of the invention is to be as set forth in the following claims.

We claim:

1. A dynamic filter member comprising a mass of lipophilic, hydrophobic fibers and bioremediating microbes, said filter member having a sufficient volume of interstitial areas such that water flow through said filter member is substantially unimpeded.

2. The dynamic filter member of claim 1, further comprising a porous cover.

3. The dynamic filter member of claim 1, wherein said mass comprises both short and long fibers, said fibers being delustered to increase their surface area.

4. The dynamic filter member of claim 1, wherein said dynamic filter member has a water flow rate of between 50 and 150 gallons per minute per square foot measured prior to absorption of hydrocarbons.

5. A method of removing hydrocarbons from moving water and remediating said hydrocarbons comprising the steps of:
providing a dynamic filter member comprising a mass of lipophilic, hydrophobic fibers and bioremediating microbes, said filter member having a sufficient volume of interstitial areas such that water flow through said filter member is substantially unimpeded, said filter member having a water flow rate of between 50 and 150 gallons per minute per square foot measured prior to absorption of hydrocarbons;
positioning said dynamic filter member in said moving water and allowing said water to flow through said dynamic filter member, whereby said hydrocarbons are retained within said dynamic filter member and said water passes from said dynamic filter member; and
allowing sufficient time for said bioremediating microbes to convert said hydrocarbons into harmless byproducts.

6. The method of claim 5, further comprising the steps of:
removing said dynamic filter member from said water prior to complete remediation of said hydrocarbons; and
maintaining suitable environmental conditions to sustain life for said microbes until bioremediation of said hydrocarbons is completed.
